(19) United States
(12) Patent Application Publication
(10) Pub. No.: US 2014/0135220 A1
(43) Pub. Date: May 15, 2014

(54) Methods for post emergent weed control with Pyroxasulfone and Lactofen

(71) Applicant: Valent U.S.A., Corporation, Walnut Creek, CA (US)

(72) Inventor: Matthew Terrence Kirkpatrick, Lathrop, MO (US)

(73) Assignee: Valent U.S.A., Corporation, Walnut Creek, CA (US)

(21) Appl. No.: 14/073,207

(22) Filed: Nov. 6, 2013

Related U.S. Application Data
(60) Provisional application No. 61/725,800, filed on Nov. 13, 2012.

(51) Int. Cl. A01N 43/80; A01N 37/48

(52) U.S. Cl. CPC A01N 43/80; A01N 37/48
USPC 504/139

(57) ABSTRACT

The invention relates to methods for controlling post emergent weeds by application of pyroxasulfone and lactofen to an area in need of weed control.

### FIELD OF THE INVENTION

The present invention is directed to methods of protecting crop plants from post emergent weeds with a combination of pyroxasulfone and lactofen.

### BACKGROUND OF THE INVENTION

The present method is directed to a method of applying effective amounts of pyroxasulfone and lactofen to an area in need of improved weed control.

One of the major concerns of crop plant growers is the presence of undesired plants, such as weeds, in the area where the crop plant is grown. Weeds contribute to decreased crop yields because the crop plants must compete with weeds for the limited available resources such as sunlight, soil nutrients, and water. Weeds can also host pests that can increase disease rates in crop plants.

Post emergent weeds are an especially concerning issue for crop plant growers because the herbicide applied for weed control can damage the young crop plants. Growers have struggled to find methods of providing adequate post emergent weed control. One way of controlling weeds has been to apply lactofen as a foliar spray following weed emergence. Previously there was no way to increase the effectiveness of lactofen without damaging the crop plant seedlings.

US Patent Application Publication No. 2010/0248964 (“the '964 application”) is directed to a herbicidal composition containing a pyridazinone compound, flumioxazin, and at least one other herbicide selected from an extensive list. The '964 application indicates that the herbicide composition of the application can be mixed with other many other herbicides including lactofen and pyroxasulfone. The '964 application fails to disclose applying pyroxasulfone with lactofen for post emergent weed control. Further, the '964 application does not suggest applying pyroxasulfone with lactofen, or applying pyroxasulfone with lactofen without a pyridazinone compound.

WO Application No. 2009/115490 (“the '490 application”) is directed to pyroxasulfone herbicide compositions containing protoporphyrinogen oxidase (“PPO”) inhibitors that can include lactofen. The '490 application mentions that the pyroxasulfone herbicide composition can be applied after the emergence of undesired plants, however, the '490 application fails to exemplify such an application. Further, the '490 application fails to disclose Applicants' effective amounts of pyroxasulfone and lactofen or Applicants' ratios of pyroxasulfone to lactofen.

Therefore, there is a need in the art for a highly effective and safe post emergence weed control method.

### SUMMARY OF THE INVENTION

Applicants have discovered that a combination of pyroxasulfone and lactofen provides excellent post emergent weed control.

On one aspect, the invention is directed to methods of post emergent weed control comprising applying an effective amount of pyroxasulfone and an effective amount of lactofen to an area in need of weed control.

In another aspect, the area in need of weed control is an area used for crop plant growth. Applicants' methods can be applied to areas growing a variety of crop plants and is effective on many types of hard-to-kill weeds.

### DETAILED DESCRIPTION OF THE INVENTION

The present invention is directed to methods of applying pyroxasulfone and lactofen to an area in need of post emergent weed control.

Pyroxasulfone (5-(difluoromethoxy)-1-methyl-3-(trifluoromethyl)pyrazol-4-ylmethyl 4,5-dihydro-5,5-dimethyl-1,2-oxazol-3-yl sulfone) is an oxazole herbicide. Pyroxasulfone inhibits shoot growth in seedlings and its primary target enzyme is a long chain fatty acid. Pyroxasulfone is very effective pre-emergence herbicide, however, its effectiveness is often unsatisfactory at low rates of treatment. As a post emergence treatment, pyroxasulfone is known to have poor activity.

Lactofen (ethyl O-[5-(2-chloro-α,α,α-trifluoro-p-tolyloxy)-2-nitrobenzoyl]-DL-lactate) is a complex ester of acifluorfen and is a nitrophenyl ether selective herbicide. Lactofen is currently used as a post emergence weed control.

Applicants surprisingly discovered applying a pre emergent herbicide, pyroxasulfone, with lactofen as a post emergence treatment resulted in increased weed control. Applicants did not expect a pre emergent herbicide to increase the effectiveness of a post emergence herbicide, especially because in previous studies pyroxasulfone exhibited poor post emergence control when applied alone.

In one embodiment, Applicants' invention is directed to methods for controlling weeds after they have emerged which includes applying an effective amount of pyroxasulfone and an effective amount of lactofen to an area in need of weed control.

In another embodiment, the ratio of ratio of pyroxasulfone to lactofen is from about 1:0.5 to about 1:2. More preferably, the ratio is from about 1:1 to about 1:2, and the most preferred ratio is about 1:2.

In a further embodiment, the effective amount of pyroxasulfone is from about 0.053 to about 0.213 per pounds active per acre. More preferably, the effective amount is from about 0.08 to about 0.106 pounds active per acre, and the most preferred effective amount is about 0.106 pounds active per acre.

In yet another embodiment, the effective amount of lactofen is from about 0.094 to about 0.188 pounds active per acre. More preferably, the effective amount is from about 0.125 to about 0.188 pounds active per acre, and most preferred, the effective amount is about 0.156 pounds active acre.

Applicants' mixtures can be applied in any convenient means. Those skilled in the art are familiar with the modes of application that include foliar applications such as spraying by ground or by aerial application.

In one embodiment, the pyroxasulfone and lactofen can be applied together as a tank mix and applied simultaneously or as a premix to an area in need of weed control.

Mixtures of the present invention can also provide residual weed control. The weeds can be controlled for several weeks with a single application as both compounds have preemergence activity.

Applicants' methods effectively kill weeds in an area planted with crop plants. Applicants' combination of pyroxasulfone and lactofen can be applied after the weeds and crop plants have germinated and emerged from the ground. The combination can be applied when the crop plants and weeds are several inches tall. For example, the weeds could be between 0.5 and 24 inches tall, or more preferably between 2 and 12 inches tall. The most preferred height of the weeds is between 2 and 6 inches tall.

Previously, herbicide treatments had to be applied when the weeds were small in order for the herbicides to be effective. Applicants' methods provide for an extended time for treatments to be effective. Further, Applicants' methods allow for control of larger weeds than those controlled by herbicides of the prior art.

In yet another embodiment, Applicants' methods can be applied successfully to crop plants and weeds that are resistant to glyphosate, ALS or triazines.

The herbicide combination of the present invention may be formulation to contain adjuvants, such as solvents, anti-caking agents, stabilizers, defoamers, slip agents, humectants, dispersants, wetting agents, thickening agents, emulsifiers, and preservatives which increase the long lasting activity of the actives. Other components that enhance the biological activity of these ingredients may optionally be included.

Mixtures of the present invention can be formulated to contain a liquid solvent.

Applicants' mixtures can also include one or more additional herbicides. Further, the mixtures can include additional ingredients to increase the effectiveness of the active ingredients.

The term “weeds” in this application includes a plant that is not desired to grow in an area. Such plants can include, but are not limited to, the following: pigweeds (Palmer amaranth, prostrate, redroot, smooth or spiny amaranth), balloonvine, beggarticks, bristly starbur, buffalobur, burcucumber, carpetweed, common cocklebur, common purslane, copperleaf (hophornbeam and Virginia) croto (tropic and woolly), devilsclaw, eclipta, Florida beggarweed, Florida pusley, groundcherry (cutleaf and lanceleaf), hairy galinsoga, hemp sesbania, jimsonweed, kochia, lanceleaf sage, mexicanweed morning glory (cypressvine, entirleaf, ivyleaf, palmleaf, pitted, purple moonflower, smallflower, and tall), nightshade (black, eastern black, and harity), poorjoe, prickly side (teawood), puncturevine, ragweed (common and giant), showy crotalaria, small melon, spurge (prostrate, spotted, and toothed), Venice mallow, waterhemp (common and tall), wild mustard, wild poinsettia, wild sunflower, and witchweed.

The mixture of the present invention can be applied to any environment in need of weed control. The environment in need of weed control may include any area that is desired to have a reduced number of weeds or to be free of weeds. For example, the herbicide combination can be applied to an area used to grow crop plants, such as a field, orchard, or vineyard. For example, Applicants' methods can be applied to areas where soybeans, peanuts, and cotton are growing.

The disclosed embodiments are simply exemplary embodiments of the inventive concepts disclosed herein and should not be considered as limiting, unless the claims expressly state otherwise.

As used herein, all numerical values relating to amounts, weight percentages and the like are defined as “about” or “approximately” each particular value, namely, plus or minus 10%. For example, the phrase “at least 5% by weight” is to be understood as “at least 4.5% to 5.5% by weight.” Therefore, amounts within 10% of the claimed values are encompassed by the scope of the claims.

The term “effective amount” means the amount of the formulation that will kill a weed. The “effective amount” will vary depending on the formulation concentration, the type of plants(s) being treated, the severity of the weed infestation, the result desired, and the life stage of the weeds during treatment, among other factors. Thus, it is not always possible to specify an exact “effective amount.” However, an appropriate “effective amount” in any individual case may be determined by one of ordinary skill in the art.

The following examples are intended to illustrate the present invention and to teach one of ordinary skill in the art how to use the formulations of the invention. They are not intended to be limiting in any way.

Cobra®, a commercially available herbicide, was used throughout the examples. Cobra® is a solution containing 23-25% lactofen by weight as the active ingredient, 55-60% hydrocarbons by weight, and 5-6% naphthalene by weight. Cobra® was used at a concentration of 2 LBAI/Gal.

An 85% pyroxasulfone by weight mixture was used throughout the examples The pyroxasulfone mixture was used at 85% w/w.

Crop oil concentrate (“COC”) is a mixture of oils and emulsifiers and was used at 100% w/w in the examples that follow. COC was used at 1% v/v in all treatments at approximate rate of 1 pt/a, except for the untreated control.

### EXAMPLES

### Example 1

In order to determine the efficacy of combinations of pyroxasulfone and lactofen, numerous treatments were applied to plots in an area with abundant Palmer Amaranth growth. Treatments were applied to Palmer that were between 1 and 2 inches tall with a water volume of 20 gallons per acre applied at 35 PSI with a ground speed of 3 MPH. Treatments were repeated 10 days after the first application on another set of plots with Palmer 3 to 12 inches tall with a water volume of 20 gallons per acre applied at 35 PSI with a ground speed of 3 MPH.

The number of living Palmer Amaranth plants was evaluated at 7, 18, 24, and 38 days following the first treatment and 8, 14, and 28 days following the second treatment. Results from this experiment are provided below in “Table 1. Effect of Pyroxasulfone and Lactofen Treatments on Palmer Amaranth.”

TABLE 1
Effect of Pyroxasulfone and Lactofen Treatments on Palmer Amaranth (% Control)

| Plot | Treatment | Rate | | 7 DAT | 8/18 DAT | 14/24 DAT | 28/38 DAT |
|---|---|---|---|---|---|---|---|
| 1 | Untreated Control | NA | | 0.0 | 0.0 | 0.0 | 0.0 |
| 2 | Pyroxasulfone | 0.213 | lb ai/a | 66.9 | 85.0 | 45.0 | 61.7 |
| 3 | Lactofen | 12.5 | fl oz/a | 66.0 | 97.7 | 97.7 | 99.0 |
| 4 | Pyroxasulfone + | 0.213 | lb ai/a | 99.0 | 99.0 | 99.0 | 99.0 |
| | Lactofen | 8.0 | fl oz/a | | | | |
| 5 | Pyroxasulfone + | 0.213 | lb ai/a | 99.0 | 99.0 | 99.0 | 99.0 |
| | Lactofen | 12.5 | fl oz/a | | | | |
| 6 | Pyroxasulfone + | 0.106 | lb ai/a | 99.0 | 99.0 | 99.0 | 99.0 |
| | Lactofen | 8.0 | fl oz/a | | | | |

Applicants surprisingly discovered that applying a combination of pyroxasulfone and lactofen to an area in need of weed control increased post emergence control of the weed Palmer Amaranth. Applicants were surprised by these results because pyroxasulfone, a known pre emergence herbicide, was not expected to have high efficacy when combined with lactofen and applied after the weeds had emerged.

### Example 2

In order to determine the efficacy of combinations of pyroxasulfone and lactofen, numerous treatments were applied to plots in an area with abundant Palmer Amaranth and Ivyleaf Morning Glory growth. Soybeans were planted approximately 22 days before treatment. Treatments were applied with a backpack sprayer with a size 6 nozzle at a pace of 3 miles per hour during dry conditions. Each treatment was done in triplicate. Treatments were applied with a water volume of 20 gallons per acre applied at 40 PSI with a ground speed of 3 MPH. At the time of treatment, Palmer Amaranth plants were approximately 2 to 6 inches tall, and Ivyleaf Morning Glory was approximately 3 to 6 inches tall. Results from this experiment are provided below in “Table 2. Effect of Pyroxasulfone and Lactofen Treatments on Palmer Amaranth” and “Table 3. Effect of Pyroxasulfone and Lactofen Treatments on Ivyleaf Morning Glory.”

TABLE 2
Effect of Pyroxasulfone and Lactofen Treatments on Palmer Amaranth

| Plot | Treatment | Rate | 6 DAT | 14 DAT | 28 DAT |
|---|---|---|---|---|---|
| 7 | Untreated Control | NA | 0.0 | 0.0 | 0.0 |
| 8 | Lactofen | 8 fl oz/a | 86.7 | 65.0 | 46.7 |
| 9 | Lactofen | 10.0 fl oz/a | 84.7 | 68.3 | 46.7 |
| 10 | Lactofen | 12.5 fl oz/a | 85.0 | 71.7 | 43.3 |
| 11 | Pyroxasulfone + | 1.5 oz wt/a | 87.0 | 81.7 | 61.7 |
| | Lactofen | 8 fl oz/a | | | |
| 12 | Pyroxasulfone + | 1.87 oz wt/a | 92.3 | 91.3 | 86.3 |
| | Lactofen | 10 fl oz/a | | | |
| 13 | Pyroxasulfone + | 2.25 oz wt/a | 96.0 | 96 | 94.3 |
| | Lactofen | 12.5 fl oz/a | | | |

TABLE 3
Effect of Pyroxasulfone and Lactofen Treatments on Ivyleaf Morning
Glory

| Plot | Treatment | Rate | 6 DAT | 14 DAT | 28 DAT |
|---|---|---|---|---|---|
| 7 | Untreated Control | NA | 0.0 | 0.0 | 0.0 |
| 8 | Lactofen | 8 fl oz/a | 61.7 | 48.3 | 20.0 |
| 9 | Lactofen | 10.0 fl oz/a | 71.7 | 58.3 | 20.0 |
| 10 | Lactofen | 12.5 fl oz/a | 68.3 | 56.7 | 23.3 |
| 11 | Pyroxasulfone + | 1.5 oz wt/a | 66.7 | 61.7 | 20.0 |
| | Lactofen | 8 fl oz/a | | | |
| 12 | Pyroxasulfone + | 1.87 oz wt/a | 76.7 | 76.7 | 31.7 |
| | Lactofen | 10 fl oz/a | | | |
| 13 | Pyroxasulfone + | 2.25 oz wt/a | 88.3 | 87.7 | 55.0 |
| | Lactofen | 12.5 fl oz/a | | | |

Applicants found that treatments with a combination of pyroxasulfone and lactofen were more effective at controlling post emergence weeds than treatments with lactofen alone.

Applicants also evaluated the phototoxicity of the treatments on soybeans. As can be seen below in “Table 4. Effect of Pyroxasulfone and Lactofen Treatments on Soybeans,” there were no phytotoxic effects 28 days following treatments.

TABLE 3
Effect of Pyroxasulfone and Lactofen Treatments on Soybeans

| Plot | Treatment | Rate | 6 DAT | 14 DAT | 28 DAT |
|---|---|---|---|---|---|
| 7 | Untreated Control | NA | 0.0 | 0.0 | 0.0 |
| 8 | Lactofen | 8 fl oz/a | 18.0 | 11.7 | 0.0 |
| 9 | Lactofen | 10.0 fl oz/a | 20.0 | 10.0 | 0.0 |
| 10 | Lactofen | 12.5 fl oz/a | 20.0 | 11.7 | 0.0 |
| 11 | Pyroxasulfone + | 1.5 oz wt/a | 23.3 | 15.0 | 0.0 |
| | Lactofen | 8 fl oz/a | | | |
| 12 | Pyroxasulfone + | 1.87 oz wt/a | 21.7 | 16.7 | 0.0 |
| | Lactofen | 10 fl oz/a | | | |
| 13 | Pyroxasulfone + | 2.25 oz wt/a | 21.7 | 16.7 | 0.0 |
| | Lactofen | 12.5 fl oz/a | | | |

1. A method for post emergent weed control comprising applying an effective amount of pyroxasulfone and an effective amount of lactofen to an area in need of weed control.

2. The method of claim 1 wherein the ratio of pyroxasulfone to lactofen is from about 1:0.5 to about 1:2.

3. The method of claim 1 wherein the ratio of pyroxasulfone to lactofen is about 1:2.

4. The method of claim 1 wherein the effective amount of an 85% by weight pyroxasulfone formulation is from about 0.053 to about 0.213 lb ai/a.

5. The method of claim 1 wherein the effective amount of an about 23-25% by weight lactofen solution is from about 0.094 to 0.188 lb ai/A.

6. The method of claim 1 wherein the pyroxasulfone and lactofen are applied simultaneously or sequentially.

7. The method of claim 1 wherein the pyroxasulfone and lactofen provide residual weed control.

8. A method of claim 1 where the crop is also emerged.

9. The method of claim 1 wherein the pyroxasulfone and lactofen are applied when the weeds are about 2 to about 12 inches tall.

10. The method of claim 9 wherein the pyroxasulfone and lactofen are applied when the weeds are about 2 to about 6 inches tall.

11. The method of claim 10 wherein the weeds are Palmer Amaranth, Ivyleaf Morning Glory, common barnyard grass, waterhemp, and common ragweed.

12. The method of claim 9 wherein the crop plants are soybean, peanut, and cotton.

13. The method of claim 9 wherein the weeds are resistant to glyphosphate, ALS or traizine compounds.
